(19) United States
(12) Patent Application Publication
(10) Pub. No.: US 2022/0349650 A1
(43) Pub. Date: Nov. 3, 2022

(54) CRYOGENIC CARBON CAPTURE AND ENERGY STORAGE

(71) Applicant: Alliance for Sustainable Energy, LLC, Golden, CO (US)

(72) Inventor: Lin Jay SIMPSON, Lakewood, CO (US)

(21) Appl. No.: 17/655,613

(22) Filed: Mar. 21, 2022

Related U.S. Application Data
(60) Provisional application No. 63/163,291, filed on Mar. 19, 2021.

(51) Int. Cl. F25J 3/06

(52) U.S. Cl. CPC F25J 3/067; F25J 3/062

(57) ABSTRACT

Provided herein are systems and methods for the processing of exhaust gases of industrial processes in order to reduce or eliminate emission of pollutants (including carbon dioxide) and store energy in the form of cryogenic liquids. Advantageously, the provided systems and methods utilize advanced heat exchanger systems to reduce or eliminate the net power required for operation. The heat exchangers are used both to reduce effluent gases to liquid temperatures as well as reheat previously cooled and separated gases, which can generate electricity via a turbo generator. The described systems and method may also produce cryogenic liquid products (Argon, Krypton, liquid Oxygen, liquid Nitrogen, etc.).

### CROSS-REFERENCE TO RELATED APPLICATIONS

This application claims priority from U.S. Provisional Patent Application No. 63/163,291 filed on Mar. 19, 2022, the contents of which are incorporated herein by reference in their entirety.

### CONTRACTUAL ORIGIN

This invention was made with government support under Contract No. DE-AC36-08GO28308 awarded by the Department of Energy. The government has certain rights in the invention.

### SUMMARY

Provided herein are systems and methods for the processing of exhaust gases of industrial processes in order to reduce or eliminate emission of pollutants (including carbon dioxide) and store energy in the form of cryogenic liquids. Advantageously, the provided systems and methods utilize advanced heat exchanger systems to reduce or eliminate the net power required for operation. The heat exchangers are used both to reduce effluent gases to liquid temperatures as well as reheat previously cooled and separated gases, which can generate electricity via a turbo generator. The described systems and method may also produce cryogenic liquid products (Argon, Krypton, liquid Oxygen, liquid Nitrogen, etc.).

In an aspect, provided is a system comprising: a) a gas inlet for receiving a gas; b) a heat exchanger fluidically connected to the gas inlet, wherein the heat exchanger is configured to condense the gas to a liquid; c) a separation system configured to separate the liquid based on composition; and d) a plurality of storage vessels configured to store the liquid based on composition and configured to recycle the liquid to the heat exchanger.

The system may further comprise a turbo generator configured to generate electric power upon recycling the liquid to the heat exchanger and enabling a phase change back to a gas. The separation system may be one or more known methods of chemical separation such as distillation, liquid extraction, phase change separators and the like.

In an aspect, provided is a method comprising: providing an effluent gas; a) flowing the gas through a heat exchanger, thereby initiating a phase change to a liquid; b) separating the liquid based on composition; c) storing the liquid in a plurality of vessels based on the composition thereby generating a plurality of purified liquids; returning one or more of the purified liquids to the heat exchanger, thereby initiating a phase change into a purified gas; flowing the purified gas into a turbo generator, thereby generating electricity.

The heat exchanger may be a simultaneous cold and heat storage heat exchanger. The heat exchanger may be a phase change material heat exchanger, for example, a graphite based phase change material heat exchanger.

The gas may be an effluent from an industrial process, for example, from steel production, cement manufacturing, dolomite processing, ammonia production, hydrogen production, ethanol production, fertilizer production or brewing.

The gas may comprise pollutants, for example, CO₂, CH₄, CO, NOₓ gases, SOₓ gases or a combination thereof. The gas may comprise atmospheric gases, for example, N₂, O₂, Ar, Xe, Kr or a combination thereof.

The separation system may be a plurality of heat exchangers, as described herein, operating at different temperatures, pressures or both. In this configuration liquid generated at a specific temperature and pressure can be removed at high purity while remaining cooled gas is provided to the next heat exchanger in a series to extract another purified liquid product, and so on.

### BRIEF DESCRIPTION OF DRAWINGS

FIG. 1 illustrates a conceptual drawing of CCCES. Air and industrial plant emissions flow through a series of heat exchangers (HX), each held at a specific strategic temperature by highly conducting cold/heat storage (CHS) materials. Individual effluent components are liquified in each heat exchanger and the liquids drained off and stored in large tanks. For example, water is liquefied at ˜273K, and CO₂ at 220K and 10 bar. After the last heat exchanger, only cold N₂ gas remains, which is liquified at a nominal pressure using a turbo-expander and a small amount of low-cost renewable electricity. When electricity is demanded (high local market price (LMP)), the cryogenic liquids are heated one at a time with the CHS-HX (i.e., stored 220K liquid CO₂ is poured into the 273K heat exchanger, which vaporizes the CO₂ and recharges the 273K CHS material). After passing through each progressively warmer heat exchanger, the vaporized and heated gases generate the high pressures needed to make electricity with a turbo-generator. Some residual pressure can be kept in the gases that go through the turbo-generator to fill high pressure gas cylinders, used for reactive renewable chemical production, or put into pipelines to be sold as commodities. Similarly, with sufficiently high market prices, the liquids can be sold as commodities, but then electricity would not be made from these stored materials. Purified liquid oxygen is one such commodity that may be worth more than the electricity it can produce, i.e., for steel production. The specific HX operating temperatures and fine design details will depend on the gas input source, and whether the CCCES is aligned with different industrial components (e.g., PV plant or which industrial exhaust sources).

FIG. 2 illustrates effluent gases formed at different stages of steel production. For every ton of steel produced on average 1.85 tons of carbon dioxide is emitted, accounting for ˜8% of carbon emissions annually. Most of the Coke Oven and Blast Furnace effluents are recaptured and reused until mainly CO₂ is left. Substantial amounts of pure O₂ is streamed through the Converter producing mainly CO. Typically, this CO is combined with large quantities of air at high temperatures to form CO₂. However, because the CCCES can capture CO directly, this enables CO (typically a better starting point than CO₂) to be used in reactive processes to form other chemicals like hydrocarbons.

FIG. 3 provides a diagram of Standard Cryogenic Energy Storage System from Highview Power Storage Pilot Plant.

FIG. 4 compares different energy storage technologies. Only CAES, CES and PHS can be used for large scale utility grid applications. CES has higher volumetric energy density than either CAES or pumped hydro and will have similar or better energy storage and power output capabilities to that of “large CABS”.

FIG. 5 illustrates a CCCES operation used for CCS and to liquefy atmospheric gases. Air or effluent from industrial plants is cooled sequentially through a series of NREL's novel thermal storage heat exchangers where high thermally conducting graphite-phase change material cools all the effluents to the same temperature. While the effluent gases are passed through the 273K HX, water vapor condense and the liquid is poured into a holding tank. The dried effluent is then pressurized to ˜10 bar and passed through the 220K HX where CO₂ liquid condenses out and is stored in a separate holding tank. This continues through a series of HXs, which separates out individual air component liquids at specific temperatures until only ˜116K N₂ gas remains. Because of the colder temperature and all the other gases being removed, far less energy is needed to liquefy the N₂ with a turboexpander. The liquids are stored until needed to generate electricity or to be sold off as industrial chemicals.

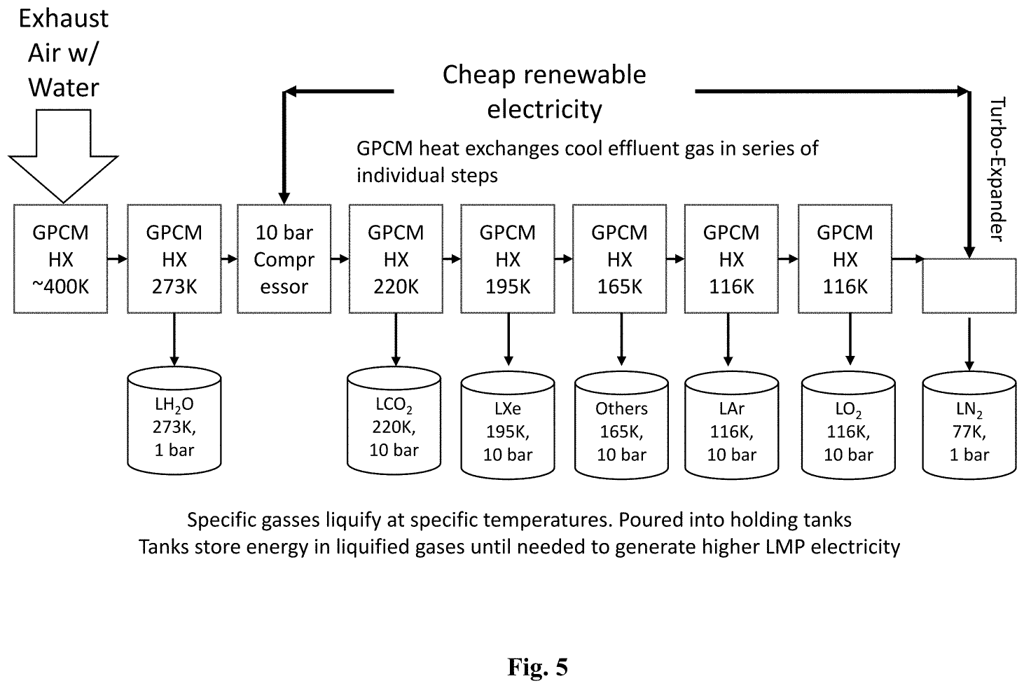

FIG. 6 illustrates a CCCES operation used to generate electricity at times of high LMP. If sufficient NPV, some cryogenic liquids can be sold directly, and will not be used to make electricity. Otherwise, most liquids will be heated and vaporized with the GPCM HXs, substantially increasing the pressure. For example, the liquid water expansion to gas ratio is 1600, which means that sufficient pressure is generated to make electricity with a turbogenerator. However, if a positive NPV is available, some of the liquids/gases can be purified and used to fill high pressure cylinders and sold as industrial chemicals. Only a small amount of the total pressure/energy generated by the heating of the cryogenic liquids will be used to fill the compressed cylinders or pipelines, the rest will be used to generate electricity.

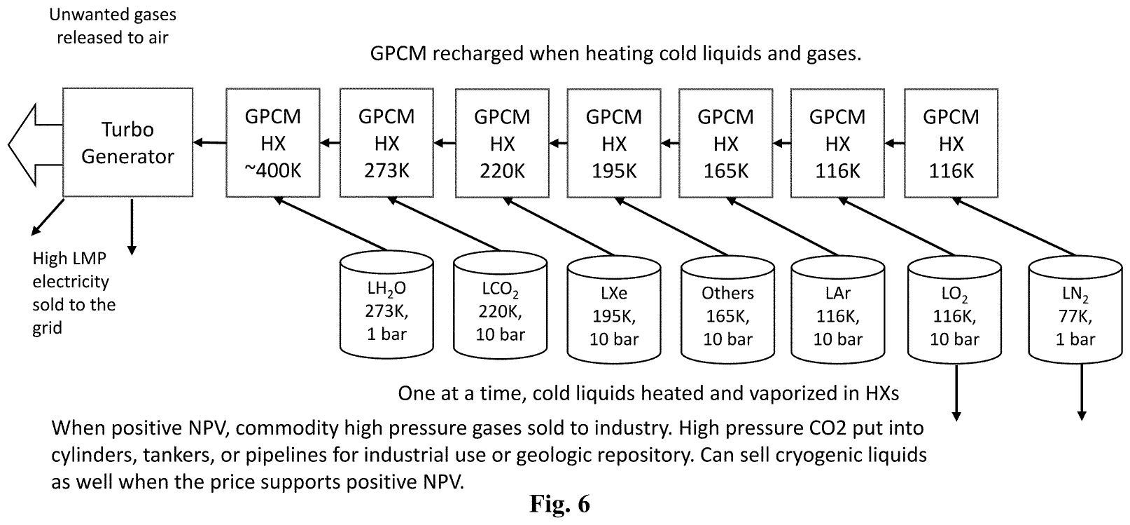

FIG. 7 illustrates a CHS-HX test configuration. Thermocouples and flow meters will measure the temperature and flow distribution through the gas flow tubes and throughout the CHS to quantify the thermal conduction performance and efficacy of novel CHS-HX to liquefy gases and heat cryogenic liquids and gases.

FIG. 8 provides an exemplary schematic of the systems described herein.

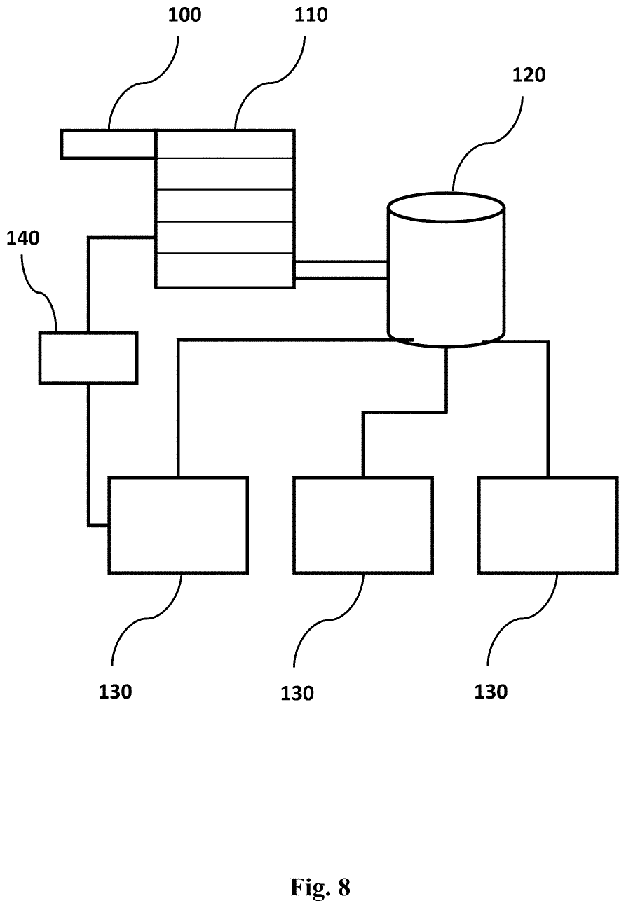

REFERENCE NUMERALS

| | |
|---|---|
| 100 | Gas inlet |
| 110 | Heat exchanger |
| 120 | Separation system |
| 130 | Storage tank |
| 140 | Turbo generator |

### DETAILED DESCRIPTION

The embodiments described herein should not necessarily be construed as limited to addressing any of the particular problems or deficiencies discussed herein. References in the specification to “one embodiment”, “an embodiment”, “an example embodiment”, “some embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

As used herein the term “substantially” is used to indicate that exact values are not necessarily attainable. By way of example, one of ordinary skill in the art will understand that in some chemical reactions 100% conversion of a reactant is possible, yet unlikely. Most of a reactant may be converted to a product and conversion of the reactant may asymptotically approach 100% conversion. So, although from a practical perspective 100% of the reactant is converted, from a technical perspective, a small and sometimes difficult to define amount remains. For this example of a chemical reactant, that amount may be relatively easily defined by the detection limits of the instrument used to test for it. However, in many cases, this amount may not be easily defined, hence the use of the term “substantially”. In some embodiments of the present invention, the term “substantially” is defined as approaching a specific numeric value or target to within 20%, 15%, 10%, 5%, or within 1% of the value or target. In further embodiments of the present invention, the term “substantially” is defined as approaching a specific numeric value or target to within 1%, 0.9%, 0.8%, 0.7%, 0.6%, 0.5%, 0.4%, 0.3%, 0.2%, or 0.1% of the value or target.

As used herein, the term “about” is used to indicate that exact values are not necessarily attainable. Therefore, the term “about” is used to indicate this uncertainty limit. In some embodiments of the present invention, the term “about” is used to indicate an uncertainty limit of less than or equal to ±20%, ±15%, ±10%, ±5%, or ±1% of a specific numeric value or target. In some embodiments of the present invention, the term “about” is used to indicate an uncertainty limit of less than or equal to ±1%, ±0.9%, ±0.8%, ±0.7%, ±0.6%, ±0.5%, ±0.4%, ±0.3%, ±0.2%, or ±0.1% of a specific numeric value or target.

The provided discussion and examples have been presented for purposes of illustration and description. The foregoing is not intended to limit the aspects, embodiments, or configurations to the form or forms disclosed herein. In the foregoing Detailed Description for example, various features of the aspects, embodiments, or configurations are grouped together in one or more embodiments, configurations, or aspects for the purpose of streamlining the disclosure. The features of the aspects, embodiments, or configurations, may be combined in alternate aspects, embodiments, or configurations other than those discussed above. This method of disclosure is not to be interpreted as reflecting an intention that the aspects, embodiments, or configurations require more features than are expressly recited in each claim. Rather, as the following claims reflect, inventive aspects lie in less than all features of a single foregoing disclosed embodiment, configuration, or aspect. While certain aspects of conventional technology have been discussed to facilitate disclosure of some embodiments of the present invention, the Applicants in no way disclaim these technical aspects, and it is contemplated that the claimed invention may encompass one or more of the conventional technical aspects discussed herein. Thus, the following claims are hereby incorporated into this Detailed Description, with each claim standing on its own as a separate aspect, embodiment, or configuration.

Described herein is a Cryogenic Carbon Capture and Energy Storage (CCCES) system using innovative plant design based on recently pioneered heat exchangers. The unique CCCES system will have higher roundtrip efficiencies (lower levelized cost of electricity, LCOE) than state-of-the-art cryogenic energy storage (CES) and substantially higher efficiencies (lower costs) than atmospheric liquefaction technology, that are already profitable, to sell commodities like liquid oxygen (LO2) and electricity at high demand times, and to inexpensively capture CO2. An important aspect of this technology is the heat exchangers that uniquely enable both large capacity heat and cold storage simultaneously where the durable liquid/solid phase-change materials are integrated with high thermally conducting materials that allow very efficient unit operations over a wide range of temperatures. The described CCCES systems, at full scale grid utility integration, will:

1. Continuously capture nearly 100% of the CO2, CH4, and other emissions from the atmosphere or industrial plant exhaust to help reduce the greenhouse gas and climate change problem;
2. Store gigawatt hours of energy in cryogenic liquids from inexpensive or free excess renewable (PV and wind) electricity with round trip LCOE less than $0.02/kWh;
3. Vaporize the cryogenic liquids on demand when high price electricity is needed; and
4. Provide LO2, CO2, Ar, Kr, Xe, N2, and CH4 as commodities to be sold to “make extra money” and recoup the carbon capture and storage (CCS) and energy storage costs.

A CCCES objective is to have round trip electrical storage-generation efficiencies greater than 70%, accordingly the energy storage and CCS will be completely paid for with locational marginal pricing changes in high versus low demand electricity of ˜30%, alone. This enables complete control of the amount of CO2 and other pollutant/greenhouse gases in the atmosphere, allows highly distributed energy storage at individual energy generation sites, and actually generates revenue selling commodity chemicals and high demand power. The CCCES systems will have several unique aspects including:

1. The lowest capital costs of any energy storage technology (i.e., $3/kWh).
2. Novel thermal storage heat exchangers that enables highly efficient simplified liquefaction and simultaneously cryogenic liquid vaporization to generate electricity on demand.
3. New CCCES design cycles optimized for CO2 capture, gas liquefaction storage, commodity chemical production, and roundtrip electricity efficiency above 70%.

### Example 1—Carbon Capture Energy Storage for Steel Manufacturing

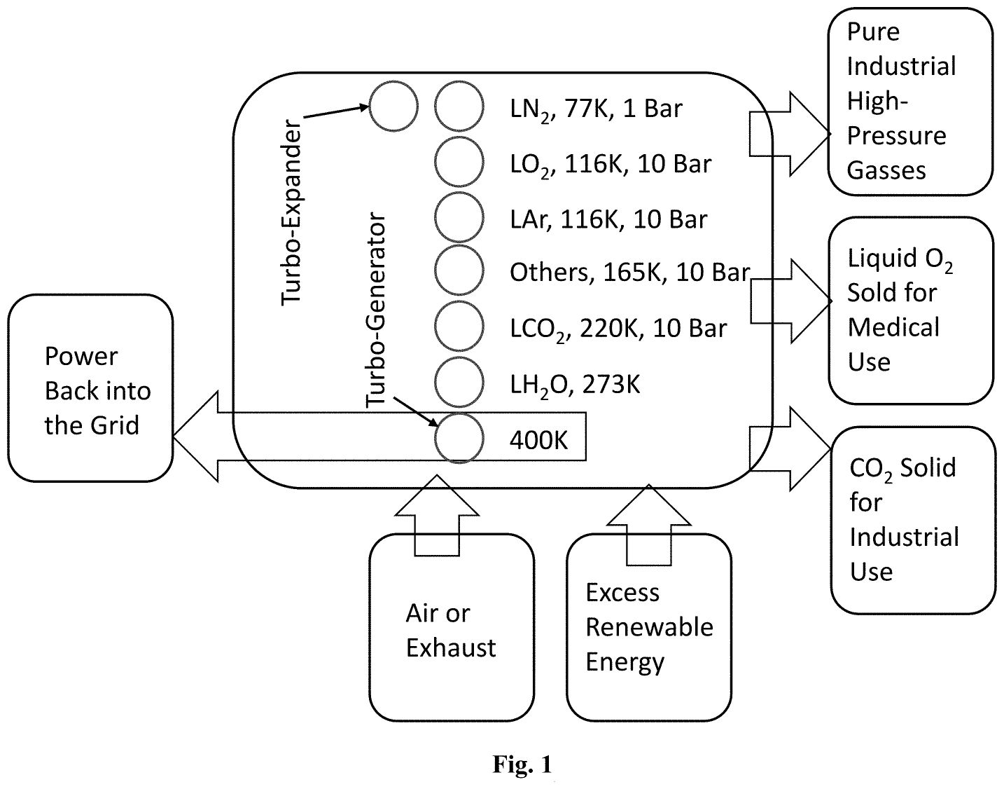

Described is a Cryogenic Carbon Capture and Energy Storage (CCCES) system for steel manufacturing using a new plant design based on our recently pioneered heat exchangers (FIG. 1). In effect, the described CCCES system will:

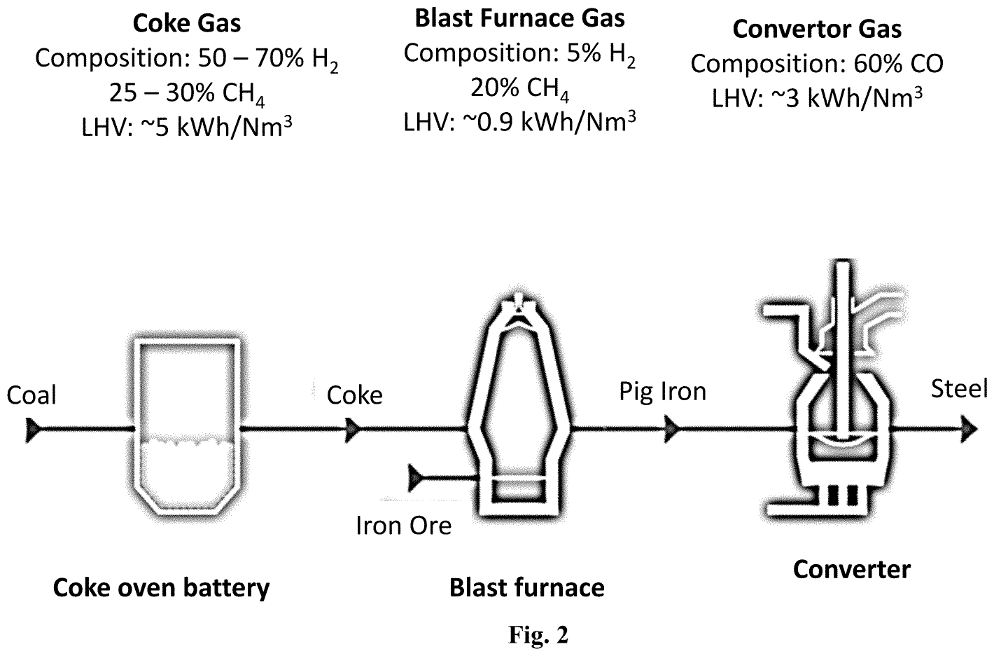

1. Substantially lower steel manufacturing costs by providing less expensive electricity and less expensive carbon free pure oxygen that are needed to process iron to steel;
2. Eliminate greenhouse gas emissions and decarbonize the air at no increased costs to the steel manufacturer, capturing/storing all effluents including changing the unit operations to capture and store the large amounts of more useful CO produced during “conversion” directly rather than after it is converted to CO₂ (FIG. 2);
3. Provide steel manufacturers with additional and new value-added products and revenue streams that include renewable electricity that can be sold at higher locational marginal pricing, liquid nitrogen, liquid oxygen, and water, and high pressure gases (e.g., xenon, krypton, nitrogen, oxygen, argon, nitric oxide, methane, carbon monoxide, and carbon dioxide) to be used in different processes.

While specific materials and process improvements may eventually reduce emissions from steel manufacturing, ultimately, to eliminate the ˜2600 million metric tons (MMT) of annual carbon emissions (and other greenhouse gas emissions like nitric oxide) today and in the near future will require advanced cross-cutting and cross-disciplinary breakthroughs that produce win-win symbiotic scenarios adapted to the specific emission point sources. The described CCCES systems can be used to reduce steel production costs, eliminate all emissions from steel manufacturing at effectively zero cost and ultimately could be used to eliminate all point source carbon emissions (from power plant, cement, hydrogen, fertilizer, and other industrial production) and even reduce atmospheric CO₂ to actually reverse global climate change by 2050.

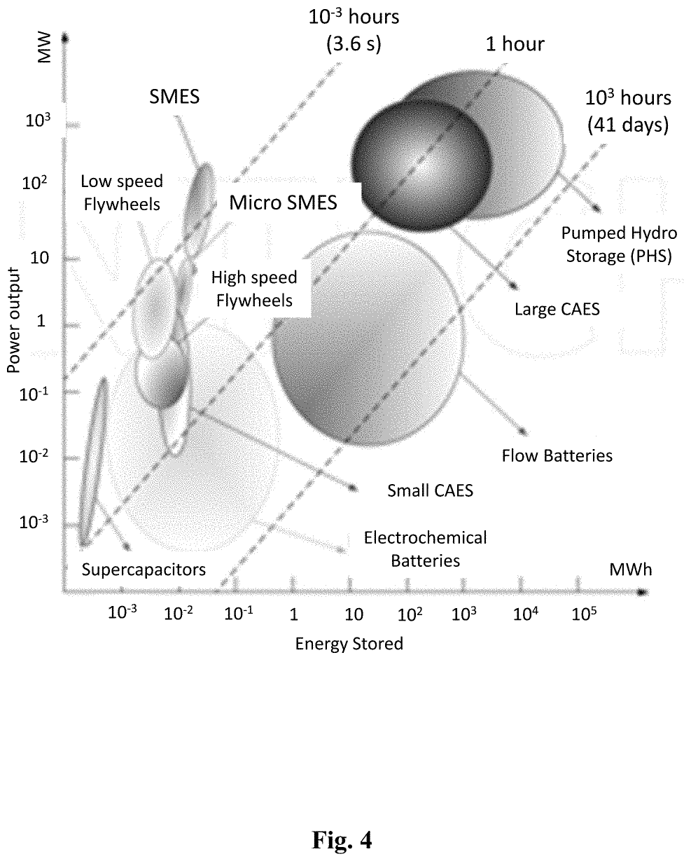

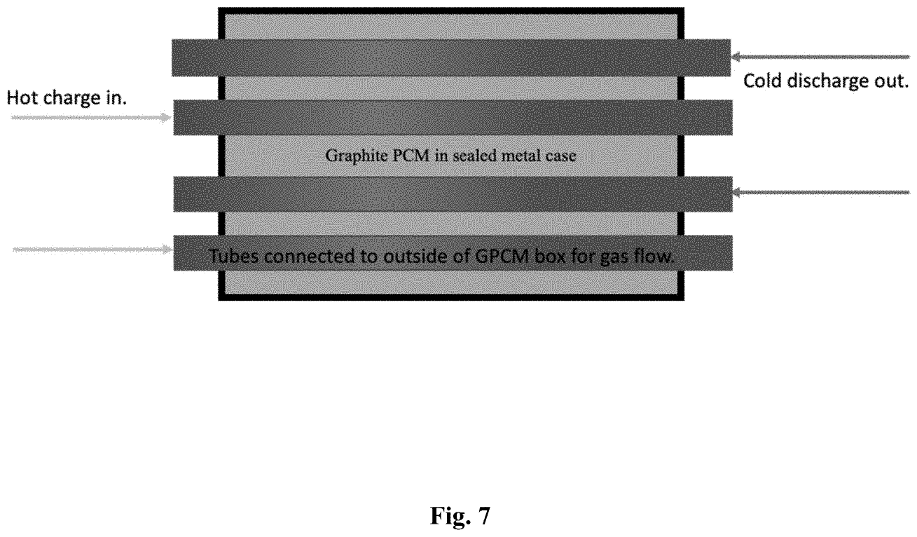

The described CCCES system uses plant design (FIGS. 1, 4 & 5) and unique thermal storage heat exchangers (FIGS. 7 & 8) to enable highly efficient and inexpensive continuous CCS and electric energy storage (via cryogenic liquefaction of steel process effluents and atmospheric gases) and electricity generation on demand. The CCCES turns the parasitic aspects of CO2 and water which are removed by desiccant filtration in standard CES into active energy storage components, thus in effect performing CCS for any effluent from industrial emissions. However, the described CCCES goes beyond standard CES by using heat exchangers (HXs) that uniquely enable simultaneously cold and heat storage (CHS) at specific strategic temperatures that substantially reduces the pressures typically needed for Claude-based liquefaction. Thus, CCCES uses low-cost renewable electricity to liquefy specific gas effluents and air in a step-wise separations process at each CHS-HX. The described CHS-HX have approximately 100 times the thermal conduction of standard CHS materials, and less than 100 times the amount of material needed by standard CES for cold storage. Additional separations of individual constituents can be performed if desired using standard liquefaction separation processes (e.g., purification of liquid oxygen to 99.5% needed for steel processing).

These liquids are stored in large tanks at relatively low pressures (i.e., 10 bar) until they are needed or sold as commodities (e.g., liquid nitrogen and liquid oxygen for industrial uses). Individual liquids can then be heated one at a time with the same CHS-HXs used in liquefaction (thus recharging them) in a step-wise process until they reach the high temperatures (and thus high pressures) needed to generate electricity. While CCCES electricity generation is basically that of compressed air, because the expanded gases start from condensed cryogenic liquids, the pressures obtained are hundreds of atmospheres, and thus high temperatures (i.e., ˜500-700° C.) from cogeneration natural gas or other industrial processes are not needed (but could be used If available), as is the case for compressed air energy storage (CAES). Furthermore, because the system uses cryogenic liquids for the energy storage that has ˜1000 times higher energy densities compared to hydroelectric, the CCCES system will require far less space than pumped hydro or CAES and ultimately may require only ˜2 mi² to provide all the future electricity storage needed for the US. The electricity can be sold back to the grid when the locational marginal pricing (LMP) is higher to create profit or used by the steel manufacturing to substantially reduce the costs of electricity and effectively insulate it from high LMP. Note that a small amount of the gas pressure can be saved to fill high pressure (i.e., ˜3000 psi) cylinders for industrial use (e.g., pure N₂, O₂, Ar, Xe, Kr, CO₂, CH₄ . . . ), to put into pipelines (e.g., ˜75 bar CO₂ and CH₄), or to be provided to on-site reactive processing (CO₂, CO, NO, CH₄, . . . ) like concentrated solar catalyzed synthesis of hydrocarbons from water, CO, and CO₂. All these purified industrial gases and liquids, including renewable hydrocarbons, provide a new set of revenue for steel manufacturing. These revenues not only completely offset the CCS of the effluents, but also lower the production costs of steel. Furthermore, all the CCCES industrial gas are made at very high efficiency potentially with renewable energy, making them much lower in cost (compared to standard liquefaction) and nearly or completely carbon free.

For steel, the vast majority of the energy used to liquefy and purify the oxygen, is then recaptured to generate electricity before it is use in the iron to steel conversion process. Presently, ˜0.15 tons of O₂ per ton of steel (˜300 MMT annually) is needed, and thus typically O₂ liquefaction and separations systems are already constructed onsite. However, these systems typically use electricity from fossil fuel power plants which actually increases steel production carbon footprint even higher than reported based on onsite emissions, and only operate at ˜10% efficiency. Our CCCES will deliver this O₂ at potentially 7 to 9 times higher efficiency, with potentially zero carbon footprint (if only renewable electricity is used).

Recently, it has been determined that for CES, the Claude-based liquefaction process had the highest exergetic efficiencies (76%-84%), but the Heylandt process had the highest roundtrip efficiency of 50%. Researchers found that for the 6 liquefaction processes analyzed, cold storage improved the liquid yield, reduced the specific power requirements by 50%-70%, and increased the exergetic efficiency by 30%-100%. Our CCCES thermodynamic modeling efforts and initial CHS-HX progress validated some of these previous results, and the general findings for cold storage. The CCCES simplifies the unit operations, and cold storage at multiple strategic temperatures enables liquefaction of many atmospheric gases (e.g., water, CO₂, Kr, Xe, Ar, CO, and O₂) without the need for expansion cooling that requires gas recycling; substantially increasing efficiency. This gain in efficiency is similar to the pre-cooling and supercooling used in liquified natural gas plants today, however, industrial refrigerants and compressors are replaced in the CCCES system with CHS-HXs that do not require any power. While these results anticipate overall roundtrip electricity storage and generation efficiencies to be well over 70%. For compressed gases, like CO₂, most of the energy used for capture and storage as a cryogenic liquid is reapplied via vaporization to generate electricity, with only a small amount of the stored energy (15% to 20%) being used to provide the 75 bar pressure needed in compressed cylinders, pipelines, or for reactive processing. In this Breakthrough Energy project, we will work with other groups to investigate how higher delivered CO/CO₂ pressures and/or temperatures can be used to enhance the conversion to more useful products. For example, on-site reactive catalysis to form hydrocarbon fuels in a concentrated solar system is expected to be enhanced with higher CO/CO₂ and water pressures.

Carbon dioxide and other emissions like methane, nitric oxide, and nitrous oxide from human related activities are causing global warming. Cement and hydrogen production each contributes ˜3% to CO₂ emissions. While emissions from fertilize manufacturing is a little lower, CO₂ from steel production results in ˜8%. In general, using our CO₂ capture technology at the emission source could completely eliminate these emissions and because of the higher CO₂ concentrations in the emissions at the source, the capture technology is typically more efficient. Furthermore, the very high temperatures associated with cement and steel production result in other emissions including nitric oxide and nitrous oxide that is 300 times more powerful as a greenhouse gas compared to CO₂, degrades the ozone layer, and can remain in the atmosphere for 100 years. In addition, steel production needs large amounts of pure oxygen, so many plants probably already have or could benefit greatly from onsite oxygen liquefaction. In addition, the CCCES system would substantially reduce the cost of this oxygen for steel by generating electricity with it before using it in the steel making process as a gas.

If all the electricity in the US and Canada were provided by renewable hydroelectric generation, then almost all of the water in the great lakes would be used annually. Thus, the scale for carbon capture and sequestration (CCS) and energy storage needed to create a zero-carbon grid is massive (terawatt hours of energy) and requires revolutionary solutions like the CCCES system (FIG. 1). Recent studies have concluded that CO₂ capture from the air using desiccant technologies is cost prohibitive. However, it has been suggested that cryogenic carbon capture may be the most cost-effective CCS process (only adding ˜$0.025/kWh to power plant LCOE; half that of typical desiccant processes), even when considering only the condensation process, and where water is removed with desiccant processing. However, this too is probably cost prohibitive for CO₂ removal from cement and steel emissions. As renewable energy starts providing over 20% of the total electricity, there will be times where rapid changes (e.g., in the solar irradiance or wind) creates excess or shortages on the utility grid that base load production cannot (or does not want to) adjust to rapidly enough. Even with less than 1% total generation, many PV plants are somewhat curtailed today, and this curtailment will only increase as PV grows. For these events, batteries and other energy storage systems are starting to become an integral part of utility grid infrastructure.

FIG. 4 shows that only Pumped Hydro Storage (PHS), Compressed Air Energy Storage (CAES) or by analogy CES (CES, which is similar to CAES, without the need for large geologic structures and natural gas turbines) systems will be able to meet the demands for gigawatt (GW) power requirements and gigawatt-hour (GWh) energy storage. Because of the extra transmission costs, both CAES and PHS often cannot be used at many sites since they require close proximity to large appropriate geologic structures. CAES is further restricted by needing to be combined as air input to commercial natural gas power turbine systems. Thus, there is a need for a new large-scale inexpensive energy storage system that is well beyond what flow batteries will be able to meet due to material limitations and higher costs. Industrial emission and atmospheric gas liquefaction and separation is a large established industry, with well-known process flows, that produce very pure gas streams and have 10%-25% efficiency in terms of energy utilization. The CCCES will substantially improve the overall liquefaction efficiency and thus lower costs for commercial industrial gases while providing additional benefits to grid electricity supply and eliminating steel and liquefaction emissions.

Described herein is a highly-efficient low-cost energy-storage technology that enables: (1) complete control of the amount of CO₂ and other pollutants/greenhouse gases in the atmosphere, (2) allows highly distributed energy storage at individual energy and/or emissions generation sites, and (3) generates revenue selling commodity chemicals and power at high demand times. The CCCES system will store low cost or close to free electricity from renewable sources by separating and liquifying the gas components in the air or exhaust from industrial plants, including capturing all of the CO₂. When electricity prices are higher, the stored cryogenic liquids are heated and vaporized, creating pressures up to 1600 times higher than ambient that is used to generate electricity via turbo-generators. Using reasonable LMP differences (i.e., 30% change in LMP prices is more than sufficient and occurs often), this approach alone can completely pay for the CCS of the emissions.

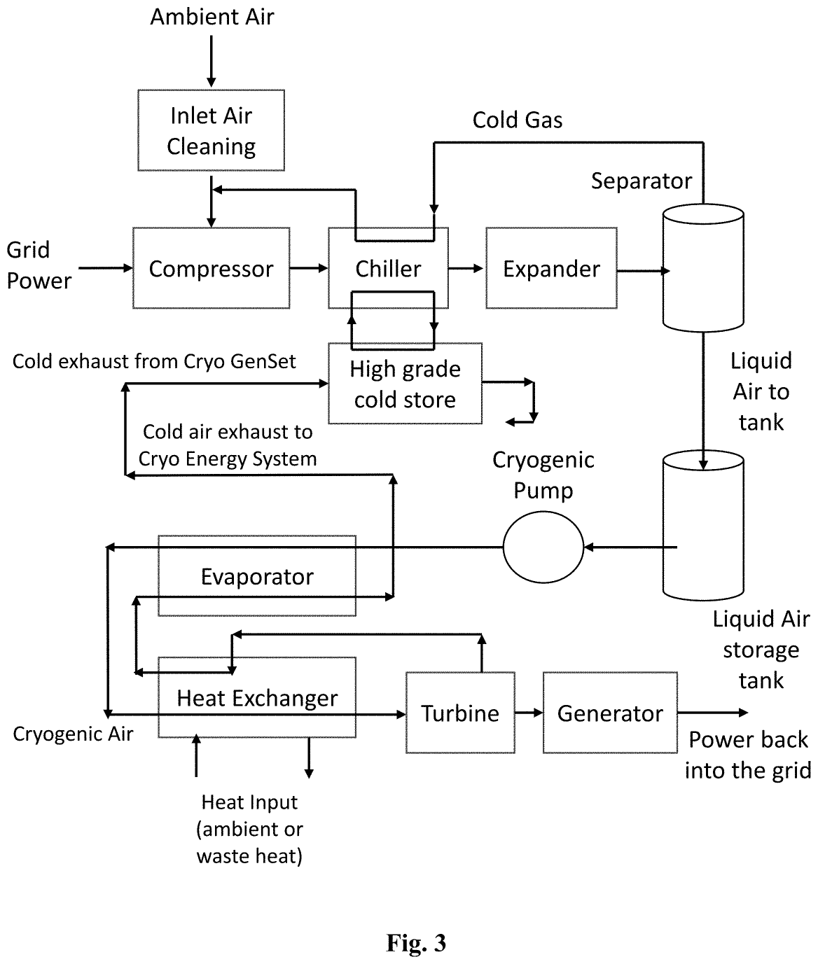

CES is used to provide CCCES cost estimates. Simply stated, CES is gas liquefaction that uses excess electricity to liquefy air/gas emissions to store energy (FIG. 3). The liquid air is subsequently heated/expanded to run a turbine when electricity is required. A Claude Cycle 350 kW (2.5 MWh) CES pilot plant was built in the United Kingdom by University of Leeds and Highview Power. By using a low-grade heat source from another industrial process and a cold storage system (e.g., large gravel beds), roundtrip efficiencies can be increased to between 50% and 70%. At these efficiencies, CES has low capital costs (i.e., $200/kW and $3/kWh, similar to CAES) and a LCOE of ˜$0.02/kWh per cycle. Low capital costs are important if some of the systems/capacity are only used a few hours a day because capital significantly impacts LCOE. Compared to CCCES, CES uses thermal storage based on sensible heats, and separate materials for heat and cold trapping, which both adds substantially to the amounts of materials needed and thus the costs. In addition, the temperatures of the thermal storage changes as more heat and cold are added or subtracted. Finally, without the co-located industrial heat source, the efficiencies will be substantially lower. With standard CES (FIG. 3), desiccants are used to remove the water and CO₂ before cryogenic liquefaction occurs. Additional energy and costs are then needed to regenerate these desiccants, and standard CES would have the same costs for CO₂ capture and sequestration as other desiccant based processes that are known to cost too much.

Value added products that create commodity revenue streams and pays for the energy storage and carbon capture: CCCES systems along with standard liquefaction purification/separation technology can be used to produce liquid N₂ and O₂, high pressure Ar, Xe, Kr, N₂, O₂, and CO₂ streams that independently generate electricity (at higher LMP) and then generate revenue resulting in a positive net present value (NPV) for the plant. Even without LMP and using a high cost of electricity for storage, CCCES may generate nearly 5 time more profit than the electricity used, even at only 50% efficiency and very low commodity prices. This is well beyond the cost of CCS and energy storage. The liquid/gas purity will be defined by the market and the cost for that purification will be supported by the commodity price. In general, CCCES electricity generation can be performed with pure or mixed gases. Overall, CCCES is the only technology that can simultaneously perform 100% CCS and meet the extremely large-scale energy storage needs of a carbon-zero grid, at a net positive revenue to the steel company or other industrial partner. This positive revenue will be met by using the NPV differences in the US 4 Trillion kWh (˜$250 B) electricity market and selling economically viable industrial commodities. For example, in conjunction with the ˜2,600 MMT of CO₂ captured, ˜300 MMT of pure oxygen will be produced annually from all the air and industrial plants in the US, which is approximately the size of the ˜$40 B global oxygen market.

Furthermore, CCCES will turn the parasitic losses of removing water and CO₂ from the air prior to liquefaction in CES into transformational and disruptive water and CO₂ commodities that are used first for energy storage. An important aspect of CCCES is CHS-HX that enable strategic set point temperature heat/cold thermal storage. This provides both liquefaction and separation as well as electricity generation from the same thermal storage heat exchangers, substantially simplifies the unit operations compared to CES and gas liquefaction and enables cost-effective retrofits to existing power plants and greenfield applications. Because of the inexpensive CHS-HXs, CCCES has the flexibility to continuously perform CCS, while at the same time generating electricity especially when demand and thus prices are high. This BEF project will spearhead the CCCES development and commercialization efforts by focusing on eliminating the ˜2600 MMT annual carbon emissions and nitric oxide emissions from steel production, which represent the largest carbon emission industry and over 8% of total carbon emissions. The zero carbon O₂ delivery by CCCES for steel alone will meet the BEF goal of reducing carbon emissions by 500 MMT annually; even if no steel carbon emissions are captured because of process changes. As discussed previously, bringing together the steel and pure O₂ industries with CCCES is very synergistic because of the high temperature effluents and the substantial decrease in costs and carbon footprint that CCCES can provide in delivered on-site oxygen for steel processing. Again, CCCES oxygen will be generated much more efficiently at the production site using renewable energy compared to present commercial air liquefaction processing presently used to provide pure oxygen.

CO₂ (and other pollutants) capture and storage from the air and flue effluent is needed now to stop catastrophic climate change. For industrial effluents with high concentrations of CO₂ (like steel), The CCCES system will economically capture and sequester CO₂. However, because most CO₂ generated today is from distributed sources (e.g., transportation), CCCES' advantage over any other CCS technology is that it may also be able to economically remove CO₂ from the air as well as from other industrial/power plant (e.g., cement, fertilizer, hydrogen, and non-renewable electricity generators) emissions to help decrease atmospheric CO₂ from all sources and thus reduce global warming and providing a true net zero-carbon world. Furthermore, after being used to generate electricity the CO₂ can be sold for some applications including petroleum pumping from wells, some commercial chemical manufacturing, for renewable reactive chemical formation of hydrocarbons, and to increase farm harvests in greenhouses.

The systems and methods described herein my be further understood by the following non-limiting examples:
Example 1. A system comprising:
   a gas inlet for receiving a gas;
   a heat exchanger fluidically connected to the gas inlet, wherein the heat exchanger is configured to condense the gas to a liquid;
   a separation system configured to separate the liquid based on composition; and
   a plurality of storage vessels configured to store the liquid based on composition and configured to recycle the liquid to the heat exchanger.
Example 2. The system of example 1, further comprising a turbo generator configured to generate electric power upon recycling the liquid to the heat exchanger and enabling a phase change back to a gas.
Example 3. The system of example 1 or 2, wherein the heat exchanger is a simultaneous cold and heat storage heat exchanger.
Example 4. The system of any of examples 1-3, wherein the heat exchanger is a phase change material heat exchanger.
Example 5. The system of any of examples 1-3, wherein the heat exchanger is a graphite-based phase change material heat exchanger.
Example 6. The system of any of examples 1-5, wherein the gas is an effluent from an industrial process.
Example 7. The system of any of examples 1-6, wherein the gas is an effluent from steel production, cement manufacturing, dolomite processing, ammonia production, hydrogen production, ethanol production, fertilizer production or brewing.
Example 8. The system of any of examples 1-7, wherein the gas comprises CO₂, CH₄, CO, NOₓ, gases, SOₓ gases or a combination thereof.
Example 9. The system of any of examples 1-8, wherein the gas comprises N₂, O₂, Ar, Xe, Kr or a combination thereof.
Example 10. The system of any of examples 1-9, wherein the separation system is a plurality of heat exchangers operating at different temperatures, pressures or both.
Example 11. A method comprising:
   providing an effluent gas;
   flowing the gas through a heat exchanger, thereby initiating a phase change to a liquid;
   separating the liquid based on composition;
   storing the liquid in a plurality of vessels based on the composition thereby generating a plurality of purified liquids;
   returning one or more of the purified liquids to the heat exchanger, thereby initiating a phase change into a purified gas;
   flowing the purified gas into a turbo generator, thereby generating electricity.
Example 12. The method of example 11, wherein the heat exchanger is a simultaneous cold and heat storage heat exchanger.
Example 13. The method of example 11 or 12, wherein the heat exchanger is a phase change material heat exchanger.
Example 14. The method of any of examples 11-13, wherein the heat exchanger is a graphite-based phase change material heat exchanger.
Example 15. The method of any of examples 11-14, wherein the effluent gas comprises one or more pollutants and where the separating step generates one or more purified pollutants that are not returned to the heat exchanger.
Example 16. The method of example 15, wherein the pollutant comprises CO₂, CH₄, CO, NOₓ gases, SOₓ gases or a combination thereof.
Example 17. The method of any of any of examples 1-16, wherein the effluent gas is from steel production, cement manufacturing, dolomite processing, ammonia production, hydrogen production, ethanol production, fertilizer production or brewing.
Example 18. The method of any of examples 1-17, wherein the step of separating is achieved by a plurality of heat exchangers operating at different temperatures, pressures or both.
Example 19. A system comprising:
   a gas inlet for receiving at least one gas;
   a heat exchanger fluidically connected to the gas inlet, wherein the heat exchanger is configured to condense the gas to a liquid;
   a separation system configured to separate the liquid based on composition; and
   a plurality of storage vessels configured to store the liquid based on composition and configured to recycle the liquid to the heat exchanger; and
   a turbo generator configured to generate electric power upon recycling the liquid to the heat exchanger and enabling a phase change to a gas;
   wherein the gas comprises Ar or Kr.
Example 20. The system of example 19, wherein the gas further comprises CO₂, CH₄, CO, NOₓ gases, SOₓ gases or a combination thereof.

The terms and expressions which have been employed herein are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments, exemplary embodiments and optional features, modification and variation of the concepts herein disclosed may be resorted to by those skilled in the art, and that such modifications and variations are considered to be within the scope of this invention as defined by the appended claims. The specific embodiments provided herein are examples of useful embodiments of the present invention and it will be apparent to one skilled in the art that the present invention may be carried out using a large number of variations of the devices, device components, methods steps set forth in the present description. As will be obvious to one of skill in the art, methods and devices useful for the present methods can include a large number of optional composition and processing elements and steps.

As used herein and in the appended claims, the singular forms “a”, “an”, and “the” include plural reference unless the context clearly dictates otherwise. Thus, for example, reference to “a cell” includes a plurality of such cells and equivalents thereof known to those skilled in the art. As well, the terms “a” (or “an”), “one or more” and “at least one” can be used interchangeably herein. It is also to be noted that the terms “comprising”, “including”, and “having” can be used interchangeably. The expression “of any of claims XX-YY” (wherein XX and YY refer to claim numbers) is intended to provide a multiple dependent claim in the alternative form, and in some embodiments is interchangeable with the expression “as in any one of claims XX-YY.”

When a group of substituents is disclosed herein, it is understood that all individual members of that group and all subgroups, are disclosed separately. When a Markush group or other grouping is used herein, all individual members of the group and all combinations and subcombinations possible of the group are intended to be individually included in the disclosure. For example, when a device is set forth disclosing a range of materials, device components, and/or device configurations, the description is intended to include specific reference of each combination and/or variation corresponding to the disclosed range.

Every formulation or combination of components described or exemplified herein can be used to practice the invention, unless otherwise stated.

Whenever a range is given in the specification, for example, a density range, a number range, a temperature range, a time range, or a composition or concentration range, all intermediate ranges and subranges, as well as all individual values included in the ranges given are intended to be included in the disclosure. It will be understood that any subranges or individual values in a range or subrange that are included in the description herein can be excluded from the claims herein.

All patents and publications mentioned in the specification are indicative of the levels of skill of those skilled in the art to which the invention pertains. References cited herein are incorporated by reference herein in their entirety to indicate the state of the art as of their publication or filing date and it is intended that this information can be employed herein, if needed, to exclude specific embodiments that are in the prior art. For example, when composition of matter is claimed, it should be understood that compounds known and available in the art prior to Applicant's invention, including compounds for which an enabling disclosure is provided in the references cited herein, are not intended to be included in the composition of matter claims herein.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. In each instance herein any of the terms “comprising”, “consisting essentially of” and “consisting of” may be replaced with either of the other two terms. The invention illustratively described herein suitably may be practiced in the absence of any element or elements, limitation or limitations which is not specifically disclosed herein.

All art-known functional equivalents, of any such materials and methods are intended to be included in this invention. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

What is claimed is:

1. A system comprising:
a gas inlet for receiving a gas;
a heat exchanger fluidically connected to the gas inlet, wherein the heat exchanger is configured to condense the gas to a liquid;
a separation system configured to separate the liquid based on composition; and
a plurality of storage vessels configured to store the liquid based on composition and configured to recycle the liquid to the heat exchanger.

2. The system of claim 1, further comprising a turbo generator configured to generate electric power upon recycling the liquid to the heat exchanger and enabling a phase change back to a gas.

3. The system of claim 1, wherein the heat exchanger is a simultaneous cold and heat storage heat exchanger.

4. The system of claim 1, wherein the heat exchanger is a phase change material heat exchanger.

5. The system of claim 1, wherein the heat exchanger is a graphite-based phase change material heat exchanger.

6. The system of claim 1, wherein the gas is an effluent from an industrial process.

7. The system of claim 1, wherein the gas is an effluent from steel production, cement manufacturing, dolomite processing, ammonia production, hydrogen production, ethanol production, fertilizer production or brewing.

8. The system of claim 1, wherein the gas comprises CO₂, CH₄, CO, NO gases, SOₓ gases or a combination thereof.

9. The system of claim 1, wherein the gas comprises N₂, O₂, Ar, Xe, Kr or a combination thereof.

10. The system of claim 1, wherein the separation system is a plurality of heat exchangers operating at different temperatures, pressures or both.

11. A method comprising:
providing an effluent gas;
flowing the gas through a heat exchanger, thereby initiating a phase change to a liquid;
separating the liquid based on composition;
storing the liquid in a plurality of vessels based on the composition thereby generating a plurality of purified liquids;
returning one or more of the purified liquids to the heat exchanger, thereby initiating a phase change into a purified gas;
flowing the purified gas into a turbo generator, thereby generating electricity.

12. The method of claim 11, wherein the heat exchanger is a simultaneous cold and heat storage heat exchanger.

13. The method of claim 11, wherein the heat exchanger is a phase change material heat exchanger.

14. The method of claim 11, wherein the heat exchanger is a graphite-based phase change material heat exchanger.

15. The method of claim 11, wherein the effluent gas comprises one or more pollutants and where the separating step generates one or more purified pollutants that are not returned to the heat exchanger.

16. The method of claim 15, wherein the pollutant comprises CO₂, CH₄, CO, NO gases, SOₓ gases or a combination thereof.

17. The method of claim 11, wherein the effluent gas is from steel production, cement manufacturing, dolomite processing, ammonia production, hydrogen production, ethanol production, fertilizer production or brewing.

18. The method of claim 11, wherein the step of separating is achieved by a plurality of heat exchangers operating at different temperatures, pressures or both.

19. A system comprising:
a gas inlet for receiving at least one gas;
a heat exchanger fluidically connected to the gas inlet, wherein the heat exchanger is configured to condense the gas to a liquid;
a separation system configured to separate the liquid based on composition; and
a plurality of storage vessels configured to store the liquid based on composition and configured to recycle the liquid to the heat exchanger; and
a turbo generator configured to generate electric power upon recycling the liquid to the heat exchanger and enabling a phase change to a gas;
wherein the gas comprises Ar or Kr.

20. The system of claim 19, wherein the gas further comprises CO₂, CH₄, CO, NOₓ gases, SOₓ gases or a combination thereof.
